(19) United States
(12) Patent Application Publication
(10) Pub. No.: US 2025/0178321 A1
(43) Pub. Date: Jun. 5, 2025

(54) BIODEGRADABLE COMPOSITE FILM WITH HIGH MOISTURE BARRIER

(71) Applicant: TORAY PLASTICS (AMERICA), INC., North Kingstown, RI (US)

(72) Inventors: Shichen DOU, North Kingstown, RI (US); Joshua R. CLOUTIER, North Kingstown, RI (US); Tracy PAOLILLI, North Kingstown, RI (US); Samuel HOGAN, North Kingstown, RI (US)

(21) Appl. No.: 18/524,194

(22) Filed: Nov. 30, 2023

(51) Int. Cl. B32B 27/08; B32B 27/18; B32B 27/36

(52) U.S. Cl. CPC B32B 27/08; B32B 27/18; B32B 27/36; B32B 2255/10; B32B 2255/205; B32B 2255/26; B32B 2255/28; B32B 2270/00; B32B 2307/31; B32B 2307/518; B32B 2307/538; B32B 2307/7244; B32B 2307/7246; B32B 2307/7376; B32B 2439/70

(57) ABSTRACT

A coextruded multi-layer biodegradable composite film was primed either in-line or off-line to form moisture-resistant anchoring structure for EVOH/PHOH barrier coating using primer coating including waterborne polyethyleneimine dispersions and waterborne polyester dispersions. The primed bioplastic composite film was then coated with EVOH/PVOH solution barrier coating. The coated composite film was then metallized through a process of vapor deposition of Aluminum metal in a metallizer chamber. The metallized films made with a process of off-line priming have O2TR in the range of 1.9 to 4.5 cc/m²/day, and MVTR in the range of 0.1 to 0.4 g/m²/day; The metallized films made with a process of in-line priming have O2TR in the range of 0.63 to 1.04 cc/m²/day, and MVTR in the range of 0.027 to 0.075 g/m²/day.

### FIELD OF THE INVENTION

This invention relates to improving the barrier properties of biaxially oriented multilayer biodegradable composite film through multilayered coating processes.

### BACKGROUND OF INVENTION

In recent years, interest in “Greener” packaging and “End of Life” has been strongly developing. Packaging materials based on biologically derived polymers are increasing due to concerns with plastic pollution, renewable resources, raw materials, and greenhouse gas generation. Bio-based plastics are believed to help reduce reliance on petroleum, reduce production of greenhouse gases, and eliminate plastic pollution, and can be biodegradable or compostable as well.

Bio-based plastics such as polylactic acid (PLA) and polyhydroxyalkanoates (PHA) derived from a renewable resource are the most popular and commercially available for packaging film applications. Polybutylene succinate (PBS) or Polybutylene succinate-co-adipate (PBSA) is a partially bio-based biodegradable polymer. Other biodegradable polymers such as poly(ε-caprolactone) (PCL) and polybutylene adipate terephthalate (PBAT) that are petroleum-based biodegradable polymers are largely available at the time of this writing to address the concerns of plastics pollution and “End of Life” of disposable single use packaging.

PLA resins are suitable to make oriented polylactic acid films with a high clarity and high gloss as well as high modulus, which are very desirable for printing graphics with high visual appearance and for forming rigid container such as stand pouches of a single materials packaging. One example could be a two-layer coextruded film structure in which a base or core layer including a crystalline PLA and a thinner “skin” layer including amorphous PLA is coextruded upon one side of the core layer and then biaxially oriented into a film. The amorphous PLA layer is often used to provide heat sealability to the film as it is non-crystalline; it has a glass transition temperature (Tg) of 56° C. to 60° C. much lower than the melting temperature of the semi-crystalline PLA resins in the core layer. PLA is the most inexpensive biodegradable polymer obtained from renewable source.

If the high modulus of BOPLA packaging (rigidity and loud noise) is an issue for its application, BOPLA film usually needs to be modified with flexible polymeric resins for better flexibility and a reduced sound level. Furthermore, PLA resins can also be modified with hydrolytic and enzymatic additives for faster compostability as well as home compostability.

Polyhydroxyalkanoates (PHAs) are a group of renewable biodegradable polyesters that are synthesized by mainly microorganisms from renewable sources including sugars obtained from lignocellulosic biomasses, agricultural wastes, starches, and vegetable oils; PHAs are completely biodegradable and converted into CO₂ and H₂O in soil and oceans. PHAs are certified compostable bioplastics that could be used for making compostable food packaging films.

However, PHA resins have a few disadvantages including their poor mechanical properties, poor thermal stability, long crystallization time, high production cost as well as incompatibility with conventional thermal processing techniques have limited their competition with traditional synthetic plastics or their application as ideal bioplastics. To overcome these drawbacks, PHA resins must be modified to meet the performance required for specific applications. PHA resins can be modified using nucleating agents to increase the speed of crystallization, and using slip agents, lubricants, and plasticizers to improve its flowability inside processing equipment (e.g. extruder and die) so that processing temperature can be reduced to preventing from thermal degradation. PHA resins can also be modified by using other biodegradable polymers including PLA, PLA copolymers, PCL, PBAT, PBS, PBSA, chemically modified starch, cellulose derivatives, and different PHA-type blends and mixtures thereof.

For such either PLA-rich or PHA-rich based biodegradable composite to be fit-for-use for many snack food packaging applications, it is desirable that the bio-based polymer film matches as many of the attributes of current snack food packaging as possible, and therefore exhibit the level of quality and performance of BOPP film which is well-known for such as controlled COF, heat sealability, printability, metallizability, barrier properties to oxygen and moisture (water vapor) etc. In particular, for high barrier packaging, metallized oriented biodegradable composite films should demonstrate good oxygen and moisture barrier properties.

For a metallized oriented PLA-rich or PHA-rich biodegradable composite film, high oxygen barrier property is generally easily achieved due to the polar nature of PLA or PHA molecular structure, which provides good hydrogen-bonding of the polymer molecules. However, this polar nature tends to easily promote the diffusion of water molecules through a polar polymer film so that it is detrimental for achieving high moisture barrier. Polar water molecules are more easily defuse through a polar polymer film than a non-polar polymer film. In order to achieve a useful protection of snack food products from staleness and/or rancidity, and to ensure a reasonably adequate shelf-life, it is preferable to have a moisture vapor transmission rate (MVTR) of at least lower than 1.0 g/m²/day or better, and more preferably, to have a moisture barrier property of 0.50 g/m²/day or lower, at 38° C. and 90% RH. It is preferable to have an oxygen transmission rate (O2TR) of at least 46 cc/m²/day or lower, and more preferably 31 cc/m²/day or lower, at 23° C. and 0% RH. The lower transmission rate, the better barrier properties.

Either PLA-rich or PHA-rich biodegradable composite films currently on the market at the time of this writing do not provide satisfactory moisture barrier properties, comparing with the moisture barrier of high barrier metallized BOPP film currently used for snack food packaging. For example, such as metallized BOPP film PWX3 (a thickness of 17.5 μm, product of Toray Plastics (America), Inc.) typically demonstrates oxygen barrier of 15.5 cc/m²/day (23° C., 0% RH) and moisture barrier of 0.155 g/m²/day (38° C., 90% RH)).

Although one could employ non-polar traditional polymers, such as polypropylene or polyethylene, that exhibit good moisture barrier properties as an outer layer to improve the effectiveness of this barrier and thereby the quality of the product, such an incorporation would impact biodegradability. To retain biodegradability, compostability and quality, the whole film structure must be disintegrated, biodegradable, compostable and commercially reasonable.

U.S. Pat. No. 9,314,999 discloses the application of sputter-deposited metal primer layer comprising copper and titanium having a weight per area of 5 to 2000 ng/cm² to improve oxygen and moisture barrier properties of metallized BOPLA film, the metallized metal primed BOPLA showed an oxygen barrier of 6.2 to 28.8 cc/m²/day (O2TR) and a moisture barrier of 0.65 to 1.17 g/m²/day (MVTR), which were improved from the O2TR of 31.0 cc/m²/day and the MVTR of 1.31 g/m²/day of metallized non-metal primed BOPLA film. Metal primer layer significantly improves the barrier properties of metallized BOPLA film, while the barrier improvement is still insufficient to the barrier required for snack food packaging.

U.S. Pat. No. 8,734,933 discloses the application of crosslinkable EVOH/PVOH barrier coatings on BOPLA film. BOPLA film was off-line coated using a series of aqueous EVOH/PVOH coating solutions (Examples 1 to 4) through a reverse-gravure coater and then were dried in air flotation oven to form a crosslinked dried coating layer with a thickness of 0.15 to 0.35 μm. The crosslinked EVOH/PVOH coating is biodegradable and home compostable and has good processability for downstream process due to its crosslinked structure containing non-polar ethylene chain segments. The coated BOPLA film was then metallized in vacuum metallizer by vapor deposition of aluminum upon the coated surface. The optical density of metal layer was controlled at about 2.0 to 3.2. The MVTR of metallized coated BOPLA film was improved to a range of 0.76 to 0.90 g/m²/day from the MVTR of 4.5 g/m²/day which was the typical MVTR of the metallized non-coated BOPLA film. Although the metallized coated film sample in Ex.7 showed good moisture barrier at about 0.19 g/m²/day, Polyvinylamine copolymer (PVAm Celanese M 6, it became Selvol Ultiloc 5003 at the time of writing the current invention) could not provide good metal appearance after metallization due to its tackiness and yellowish color. Therefore, the moisture barrier of metallized BOPLA film still needs to be improved to below the uplimit MVTR 0.5 g/m²/day required for snack food packaging.

U.S. Pat. No. 9,492,962 discloses the application of about 5 wt % SEBS rubber (Kraton 1924X melt-blended in Polymer “A”) into the core layer of BOPLA film for sound dampening (Example 13), the BOPLA film was coated with EVOH/PVOH barrier coating and then metallized. Surprisingly, the metallized film showed a MVTR of 0.30 g/m²/day, compared to the control MVTR (CEX 1) of 0.81 g/m²/day, achieving significant moisture barrier improvement, matching the moisture barrier required for snack food packaging. TEM experiment confirmed that polyolefin-based SEBS in the core layer formed non-polar SEBS nano-layered stripe structure after orientation, which blocked moisture diffusion, having an effect of improving moisture barrier properties. One obvious disadvantage for use of SEBS in the core layer even if at a low content not more than 5 wt % loading to improve moisture barrier could be its petroleum-based source and non-biodegradability.

U.S. Pat. No. 10,472,150 discloses the application of coated metal oxide layer as barrier coating on PLA base film. PLA film was offline coated with a metal oxide layer comprising aluminum oxide, titanium oxide and aluminum-titanium oxide using the method of atomic layer deposition to a thickness of 3 nanometers. The metal oxide coating layer is transparent and brittle. The coated PLA film has a moisture vapor transmission rate less than 4 g/m²/day, which is much higher than the uplimit MVTR 0.5 g/m²/day required for snack food packaging.

U.S. patent application No. 20220161980A1 discloses the application of oxidative degradable polyolefin polymers such as Oxo-PE at an amount of 20 wt % or more blended with PLA and PBAT in the composition of a film which was oxo-degradable or biologically disintegrable. The film was laminated with “barrier paper” using adhesive lamination, and the laminate had barrier properties of O2TR at the range of 0.22 to 0.30 cc/m²/day and MVTR at the range of 0.61 to 0.73 g/m²/day. The laminate was neither industrial compostable nor home compostable because of the high content in oxo-degradable polyolefins in the structure of the film.

It would be desirable to provide a sustainable film which is not only biodegradable and compostable but also has sufficient high moisture barrier required for snack food packaging. Inventors demonstrate a method to produce biodegradable films with high moisture barrier.

### SUMMARY OF INVENTION

To resolve the moisture barrier issue of biaxially oriented biodegradable and compostable films, inventors seek to use various coatings such as polyethyleneimine (PEI) primer, EVOH/PVOH barrier coating, and metal or metal oxide coating as well as processes of in-line coating and off-line coating to improve moisture barrier properties of biaxially oriented biodegradable composite films. In an embodiment, biaxially oriented biodegradable and compostable film was in-line or off-line primed, then the primed composite film was coated with cross-linkable EVOH/PVOH barrier coating, and then the coated film was metallized by vapor deposition of aluminum upon the coated surface.

In an embodiment relates to a multi-layer biodegradable and compostable composite film coated on one side with aqueous based polyethyleneimine (PEI) dispersion or polyester dispersion.

In an embodiment, the film was off-line coated with aqueous polyethyleneimine dispersion or polyester dispersion as an anchoring primer of barrier coatings. The coat weight of the dried primer layer is in the range of about 0.005 to about 0.15 g/m² (gsm), preferably, about 0.02 to about 0.1 gsm.

In an embodiment, the film was in-line coated with aqueous polyethyleneimine dispersion or polyester dispersion as an anchoring primer of barrier coatings. The primer was gravure coated on the MDO film and then was sent to TDO tenter oven for orientation. The primer layer was stretched together with the substrate of the biodegradable composite film in transverse direction. The coat weight of the dried primer layer is in the range of about 0.005 to about 0.15 gsm, preferably, about 0.02 to about 0.1 gsm.

In an embodiment, the primed composite film was off-line coated on the top of primer layer with the aqueous dispersion of cross-linkable EVOH/PVOH barrier coating. The coat weight of the dried EVOH/PVOH is in the range of about 0.15 to about 0.5 gsm.

In an embodiment, the EVOH/PVOH-coated composite film was off-line metallized by vapor deposition of aluminum on the coated surface to an optical density in the range of about 1.5 to about 4.0 OD, preferably about 2.0 to about 3.0 OD.

In an embodiment, the core layer of the biaxially oriented biodegradable and compostable films comprise at least about 95 wt % of biodegradable plastics which is either industrial compostable or home compostable.

In an embodiment, wherein the biodegradable resins in the core layer (B) comprise PLA, PHA, PBAT, PCL, PBS, PBSA, and chemically modified starches, or mixtures thereof, which is either industrial compostable or home compostable. In one embodiment, wherein the PLA resin in the core layer semi-crystalline PLA resin, amorphous PLA resin, and PLA copolymers such as PLA-co-GA, PLA-co-3HP, and PLA-co-ε-CL copolymers or mixture thereof.

In an embodiment, wherein the PHA resin in the core layer includes semi-crystalline PHA resins and amorphous PHA resins such as PHB and PHB copolymers, PHBV, PHB-co-4HB, PHB-co-3HV, PHB-co-3HHx, PHB-co-3HO, and PHB-co-4HHx or mixtures thereof.

In an embodiment, the outer layers (A and C) comprise biodegradable resin composition which is either industrial compostable or home compostable.

In an embodiment, the outer layers (A and C) comprise biodegradable resin composition at an amount of about 95 wt % the total weight of the polymeric resin in the outer layers.

In an embodiment, the core layer comprises additives including organic low molecular weight additives such as nucleating agent, chain extenders, slip agent, hydrolytic promoters, enzymes, plasticizers, processing aids; and non-migratory inorganic particles such as nanoclay, talc, CaCO₃ or TiO₂ or mixtures thereof. The additives can be pre-compounded into either PLA resin or PHA resin.

In an embodiment, the core layer further comprises an amount of less than about 5 wt. % petroleum-based polymeric modifier with a glass transition temperature of Tg≤10° C.

In an embodiment, the first outer layer comprises non-migratory inorganic particles such as antiblocks, nanoclay, talc, CaCO₃ or TiO₂ or mixtures thereof at an amount of less than about 20 wt. % of the total weight of the first outer layer.

In an embodiment, the core layer comprises migratory organic additives at a small amount of less than about 0.5 wt. % of the total weight of the core layer such as chain extender, nucleating agent, anti-oxidant, and processing aids or mixtures thereof.

In embodiment, the first outer layer is a coating receiving layer to be coated with primer coating through inline or offline processes.

In an embodiment, the second outer layer has the same composition as the first outer layer.

In an embodiment, the second outer layer has a composition different from the first outer layer.

In an embodiment, the second outer layer is a heat sealant layer.

In an embodiment, the film is made by coextrusion and casting or blown process.

In an embodiment, the film is either oriented in machine direction (MD), or oriented in both machine direction (MD) and transverse direction (TD).

In an embodiment, the film is oriented in machine direction (MD) for about 2 to about 3.5 times and in transverse direction (TD) for about a3 to about 5 times.

In an embodiment, the outer layers comprise non-migratory inorganic and organic anti-blocks for COF control, which do not plate out on the surface of the processing equipment.

In an embodiment, the outer layers comprise an amount of antiblock particles with a spherical size of about 2 to about 6 μm.

In an embodiment, a loading of the antiblock particles in the outer skin layers is in the range of about 100 to about 5000 ppm of a total weight of the cap layer.

In an embodiment, a thickness of the film is about 10 μm to about 100 μm.

In an embodiment, the thickness of the film is about 15 μm to about 30 μm.

In an embodiment, the outer layers of the film have a thickness of about 1 μm to about 5 μm.

In an embodiment, the present invention provides a method to make oriented biodegradable composite film with high moisture barrier as well as high oxygen barrier properties for packaging application.

An embodiment relates to a film comprising: a core layer comprising a first biodegradable polymeric resin comprising a PLA resin or a PHA resin in an amount at least about 70 wt. % of total weight of the polymeric resins in the core layer, an outer layer comprising a second biodegradable polymeric resin; a barrier coating layer comprises EVOH or PVOH or a combination thereof, and a metal layer comprising a metal; wherein the film is a biaxially oriented film; and wherein the film has a moisture vapour transmission rate (MVTR) about 0.5 g/m²/day as measured according to ASTM F1249 and an oxygen transmission rate (O2TR) less than about 5 cc/m²/day as measured according to ASTM D3985.

In an embodiment, the film comprises a primer layer between the outer layer and the barrier coating layer.

In an embodiment, the primer layer comprising a coating comprising polyethyleneimine.

In an embodiment, the coating comprises polyester.

In an embodiment, the film is industrial compostable according to ASTMD 6400 and/or ASTM D5388 (2021).

In an embodiment, the film is home compostable according to AS 5810-10 (2010).

In an embodiment, the film has an in-line coating of the primer layer.

In an embodiment, the film has an off-line coating of the primer layer.

In an embodiment, film has the MVTR about 0.027 g/m²/day to about 0.075 g/m²/day as measured according to ASTM F1249 and the O2TR less than about 0.63 cc/m²/day to about 1.04 cc/m²/day as measured according to ASTM D3985.

In an embodiment, film wherein has O2TR in a range of about 1.9 cc/m²/day to about 4.5 cc/m²/day and MVTR in the range of about 0.1 cc/m²/day to about 0.4 g/m²/day.

In an embodiment, wherein the coating is water soluble dispersion.

In an embodiment, film comprises a first outer layer and a second outer layer, wherein the first outer layer is adjacent to first side of the core and the second outer layer is adjacent to second side of the core layer which is opposite the first side of the core layer.

In an embodiment, a primer layer is adjacent to the first outer layer.

In an embodiment, the second outer layer is a heat sealant layer.

In an embodiment, wherein the primer coating has a dried coat weight of about 0.01 gsm to about 0.1 gsm.

In an embodiment, wherein the EVOH or PVOH or a combination thereof are waterborne cross linkable.

In an embodiment, barrier layer has a dried coat weight of EVOH or PVOH or a combination thereof in a range of about 0.15 gsm to about 0.5 gsm.

In an embodiment, wherein the core layer, the outer layer, the primer layer, the barrier and the metal layer are arranged in this order.

In an embodiment, wherein a composition of the first outer layer and the second outer layer are same.

In an embodiment, wherein a composition of the first outer layer and the second outer layer are different.

the first outer layer has a surface roughness Ra in a range of 20 to 200 nm.

In an embodiment, the first outer layer has a surface roughness Ra in the range of 20 to 100 nm.

In an embodiment, the film has a thickness of about 10 μm to about 100 μm.

In an embodiment, the film has a thickness of about 15 μm to about 30 μm.

In an embodiment, the outer layer comprises antiblock particles in a loading in a range of 100 ppm to 5000 ppm of a total weight of the outer layer.

In an embodiment, the antiblock particles have a spherical size of about 2 μm to about 6 μm.

In an embodiment, the outer layer of the film has a thickness in a range of about 1 μm to about 6 μm.

In an embodiment, the second biodegradable polymeric resin comprises PLA, PHA, PBS, PBSA, PCL, PBAT, a PGA copolymer, a PLA copolymer, a PHA copolymer, a chemically modified thermoplastic starches or combination thereof.

In an embodiment, the core layer comprises an amount of less than about 5 wt % a petroleum-based polymeric modifier with a glass transition temperature of Tg≤10° C.

In an embodiment, the film is oriented about 2 to about 3.5 times in machine direction (MD) and 3 to 5 times in transverse direction (TD).

In an embodiment, the film further comprises non-migratory inorganic particles comprising an antiblock, a nanoclay, a talc, CaCO₃ or TiO₂ or mixtures thereof.

In an embodiment, the film is substantially free of a fibre.

In an embodiment, the fibre comprises a cellulosic fibre.

In an embodiment, the film comprises less than 5 wt. % of the fibre.

An embodiment relates to a film comprising a core layer having a first side and a second side, a first outer layer adjacent to the first side, an in-line primer coating layer adjacent to the first outer layer, a barrier coating layer adjacent to the in-line primer coating layer coating layer, and a metal layer adjacent to the barrier coating layer; wherein: the core layer comprises a biodegradable polymer comprising a PLA resin or a PHA resin in an amount at least about 90 wt. % of total weight of a polymeric resins in the core layer, the in-line primer coating layer comprises a polyethyleneimine polymer or a polyester, the barrier coating layer comprises EVOH or PVOH or combination thereof, and the metal layer comprises a metal; wherein the core layer is substantially free of a fibre; and wherein the film is a biaxially oriented film.

In an embodiment, the film is oriented about 2 to about 3.5 times in machine direction (MD) and 3 to 5 times in transverse direction (TD).

In an embodiment, wherein the film has a moisture vapour transmission rate (MVTR) about 0.027 g/m²/day to about 0.075 g/m²/day as measured according to ASTM F1249 and an oxygen transmission rate (O2TR) less than about 0.63 cc/m²/day to about 1.04 cc/m²/day as measured according to ASTM D3985.

In an embodiment, the core layer comprises an amount of less than 5 wt % a petroleum-based polymeric modifier with a glass transition temperature of Tg≤10° C.

An embodiment relates to a film comprising a core layer having a first side and a second side, a first outer layer adjacent to the first side, a primer coating layer adjacent to the first outer layer, a barrier coating layer adjacent to the in-line primer coating layer coating layer, and a metal layer adjacent to the barrier coating layer; wherein: the core layer comprises a biodegradable polymer comprising a PLA resin or a PHA resin in an amount at least about 90 wt. % and less than about 5 wt % a petroleum-based polymeric modifier with a glass transition temperature of Tg≤10° C. of a total weight of a polymeric resin in the core layer, the primer coating layer comprises a polyethyleneimine polymer or a polyester, the barrier coating layer comprises EVOH or PVOH or combination thereof, and the metal layer comprises a metal; wherein the core layer is substantially free of a fibre; and wherein the film is a biaxially oriented film.

### BRIEF DESCRIPTION OF THE DRAWINGS

The accompanying drawings, which are included to provide further understanding of the present invention disclosed in the present disclosure and are incorporated in and constitute a part of this specification, illustrate aspects of the present invention and together with the description serve to explain the principles of the present invention. In the drawings:

FIG. 1 Moisture barrier properties of coated biodegradable composite film.

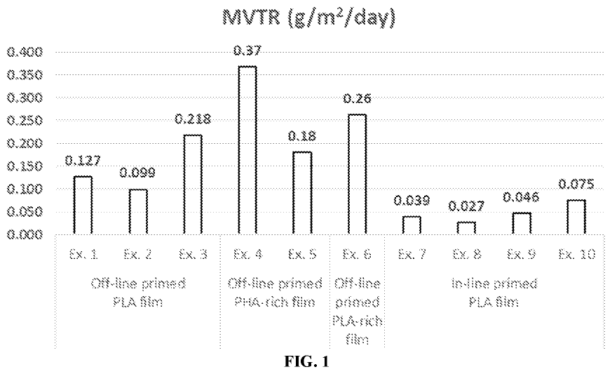

### DETAILED DESCRIPTION

### Definitions and General Techniques

For simplicity and clarity of illustration, the figures illustrate the general manner of construction, and descriptions and details of well-known features and techniques may be omitted to avoid unnecessarily obscuring the present disclosure. Additionally, elements in the figures are not necessarily drawn to scale. For example, the dimensions of some of the elements in the FIGURES may be exaggerated relative to other elements to help improve understanding of embodiments of the present disclosure. The same reference numerals in different FIGURES denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

No element, act, or instruction used herein should be construed as critical or essential unless explicitly described as such. Also, as used herein, the articles “a” and “an” are intended to include items, and may be used interchangeably with “one or more.” Furthermore, as used herein, the term “set” is intended to include items (e.g., related items, unrelated items, a combination of related items, and unrelated items, etc.), and may be used interchangeably with “one or more”. Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

As defined herein, two or more elements are “integral” if they are comprised of the same piece of material. As defined herein, two or more elements are “non-integral” if each is comprised of a different piece of material.

As defined herein, “approximately” or “about” can, in some embodiments, mean within plus or minus ten percent of the stated value. In other embodiments, “approximately” or “about” can mean within plus or minus five percent of the stated value. In further embodiments, “approximately” can mean within plus or minus three percent of the stated value. In yet other embodiments, “approximately” or “about” can mean within plus or minus one percent of the stated value.

The numeric values such as amount, weight, concentration as mentioned in some embodiments, are intended to include approximate variation of the mentioned value to the practical extent possible. For example: 20 could include approximate variation of 20±2, whereas value 0 can include only possible variation of less than 1.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Unless otherwise defined herein, scientific and technical terms used in connection with the present invention shall have meanings that are commonly understood by those of ordinary skill in the art. Further, unless otherwise required by context, singular terms shall include pluralities and plural terms shall include the singular. Generally, nomenclatures used in connection with, and techniques of, health monitoring described herein are those well-known and commonly used in the art.

The methods and techniques of the present invention are generally performed according to conventional methods well known in the art and as described in various general and more specific references that are cited and discussed throughout the present specification unless otherwise indicated. The nomenclatures used in connection with, and the procedures and techniques of embodiments herein, and other related fields described herein are those well-known and commonly used in the art.

The following terms and phrases, unless otherwise indicated, shall be understood to have the following meanings.

As used herein, the terms “on”, “applied on/over”, “formed on/over”, “deposited on/over”, “overlay” and “provided on/over” mean formed, deposited, or provided on but not necessarily in contact with the surface. For example, a coating layer “formed over” a substrate does not preclude the presence of one or more other coating layers of the same or different composition located between the formed coating layer and the substrate. It is to be understood that the layers can either be directly contacting each other or have another layer or feature between the layers, unless expressly stated to the contrary. Thus, these terms are simply describing the relative position of the layers to each other and do not necessarily mean “on top of” since the relative position above or below depends upon the orientation of the device to the viewer.

“Outer layer” is defined as the outermost layer of a coextruded sheet or film or composite. The outer layer has direct contact to the surface of the processing equipment. The outer layers comprise antiblocks for COF control and providing protection to surface scratching.

“Polymer” is a macromolecule compound prepared by polymerizing monomers of the same or different type. Polymer includes homopolymers, random copolymers, block copolymers terpolymers, tetrapolymer, and so on. “Homopolymer” is a polymer by polymerizing one monomer and has the same repeating unit in the polymer chain. “Copolymer” is a polymer derived from more than one species of monomers or comonomers. “Terpolymer” is a polymer made by polymerizing three different monomers and “Tetrapolymer” is a polymer by polymerizing four different monomers, and so on. “Random copolymer” is defined as a polymer in which the comonomers are located randomly in the polymer molecular structure.

In an embodiment, polymers could include additional additives. The polymer is interchangeable used as “resin”.

“Biaxially oriented film” is a film that is stretched in both machine and transverse directions, producing molecular chain orientation sequentially or simultaneously in two directions. A biaxially oriented film has much higher tearing strength in machine direction in comparison with a blown film which is mainly oriented in machine direction. In addition, a blown film can also have high heat shrinkage in machine direction.

“Biodegradable Bioplastics” or “Biodegradable Film” or “Compostable Composite Film” or “biodegradable film” or similar refer to polymeric materials that are ‘capable of undergoing decomposition into carbon dioxide, methane, water, inorganic compounds, or biomass in which the predominant mechanism is the enzymatic action of microorganisms, that can be measured by standardized tests, in a specified period of time, reflecting available disposal condition’. In an embodiment, more than 50%, 60%, 70%, 80%, 90% of the film could be degraded by the microbial action. In an embodiment, the film could be fully degraded by the microbial action.

In an embodiment, the biodegradable film has a home composting property as described by AS 5810-2010 standard.

In an embodiment, the biodegradable film is industrial compostable as described by AS™ D6400 standard.

“Bioplastic” is not equivalent to “biodegradable”. Bioplastic is any plastic material that is made from renewable sources. This is commercially happening with biodegradable materials as well as non-biodegradable materials like polypropylene and polyethylene.

Biodegradable means that the material will degrade and be consumed, but the source of the material could be conventional petrochemical or renewable resources. Biodegradable is well known as a term.

“EVOH/PVOH” refers to either EVOH (polyethylene vinyl alcohol) or PVOH (polyvinyl alcohol) or a mixture of EVOH and PVOH. In the mixture, the amount of EVOH could vary from about 1 wt. % to about 99 wt. % in a total weight of the mixture. In certain embodiments, EVOH and PVOH are equal. In certain embodiments, EVOH is more than PVOH. Yet in certain embodiment, PVOH is more than EVOH in the mixture.

“Barrier coating layer” refers to an environmental barrier layer such as moisture, oxygen, etc. In an embodiment, barrier coating layer may be a single layer or multiple layers. In an embodiment, barrier coating layer may be applied to a portion of the film or complete film.

“Metal layer” refers to layer having a metal or metal oxide. In an embodiment, the metal layer may have a single metal or multiple metals or their metallic compounds. Metals could be aluminum, silicon, zinc, copper, etc. or their oxide forms such as aluminum oxide, silicon oxide, zinc oxide, copper oxide etc. In an embodiment, barrier coating layer may be applied to a portion of the film or complete film.

“Coating” includes uniform application of the material as well as non-uniform application of the material, Non-uniform application could be for example: at one portion of a layer the material may be deposited more than other portions, or at some portion the coating of the material may not be deposited. Coating may be in line coating or offline coating, unless contrary is disclosed explicitly.

“Dried coat weight” can be defined as that the moisture content in the dried coat is less than about 200 PPM such as about 150 PPM, about 100 PPM, about 75 PPM, about 50 PPM or less.

“In-line primer coating layer” is defined as that the primer coating layer is coated onto the biodegradable composite film in the film making process before the orientation in transverse direction.

“Off-line primer coating layer is defined as that the primer coating layer is coated onto the biodegradable composite film after the film has been oriented and priming process is completed on separate coating equipment different from a line of film production.

“substantially free of a fibre” is defined as less than 5 wt. % of a fibre. Fibre could be one or more natural fibres or otherwise. In an embodiment, fibre is a cellulosic fibre as described in US US20120177859A1, which is incorporated by reference in its entirety.

“Crystallinity” refers to the degree of highly organized order structure excluding the fraction of amorphous phases in a resin.

“Semi-crystalline” or “semicrystalline” refers to a polymer that exhibits highly organized and tightly packed molecular chains. “Semi-crystalline” may be simplified as “crystalline” as in comparison with “amorphous”. The crystalline regions are called spherulites and can vary in shape and size with amorphous regions existing between the crystalline regions. As a result, this highly organized molecular structure has a defined melting temperature point.

Typically, a semi-crystalline resin has a degree of crystallinity in the range of from 10 wt % to 80 wt % of the total weight of the resin.

“Amorphous resin” has a randomly ordered molecular structure which does not have a sharp melting temperature point. Such a resin often softens or solidifies as its temperature is changed to above Tg or below Tg.

“Glass transition temperature, Tg” is a thermal property associated with the long-range segmental mobility of polymer chains. As the temperature increases above Tg, a resin starts softening; as the temperature drops below Tg, the resin starts solidifying. Tg governs the rigidity, toughness and flexibility of the polymer in a specific temperature range. Under ambient temperature condition, a polymer film with a Tg higher than ambient temperature, it is rigid, otherwise it is flexible as it has a Tg below ambient temperature.

“Modifier” refers to materials that are added into the resin to improve the properties of a biaxially oriented composite film such as but not limited to improving heat-sealability, mechanical strength (flexibility, modulus, tensile strength, elongation, etc.), thermal stability, biodegradability, compostability, optical properties, and surface properties and so on. In an embodiment, modifier could be added in the resin during an appropriate step of polymerization, melt compounding, dry blending and coextrusion processes at a desirable amount.

Low molecular weight molecules or components” is defined as any additives such as plasticizers, enzymes, hydrolytic promoters, slip agents, monomers, and oligomers found in a polymeric composition or materials could transfer to the surface of processing equipment or the article inside a packaging by direct contact or migration during processing or packaging.

“Non-home-compostable but industrial compostable polymeric composition” is defined as biodegradable polymers such as PLA resins which pass industrial composting test but fail in home composting test.

TUV-certified home compostable polymer or materials: TÜV AUSTRIA (formerly Vinçotte) is a certification body authorized by European Bioplastics, it may therefore certify and award “OK COMPOST HOME” to products that pass the requirements for home compostable packaging in biodegradation, disintegration, compost quality (ecotoxicity) and chemicals (heavy metals). The test of disintegration and biodegradation is aerobic in inoculum in home composting reactor under a controlled temperature environment of 25±5° C. according to AS 5810-10 (2010) or “OK HOME COMPOST CERTIFICATION 2019 VERSION”. All test conditions are the same as that used in industrial composting test (ASTMD 6400 and ASTM D5388 (2021), test temperature 58° C.) except that the test temperature is much lower. The maximum allowed test duration for disintegration is six months. The maximum duration time for biodegradation to reach about 90% absolute or relative biodegradation is about 12 months.

### Materials and Properties

PLA resin is considered as a rigid biopolymer which is available at large commercial scale with a relative low cost. Examples of semi-crystalline PLA resin include Nature Works Ingeo™ PLA4032D and PLA4043D or Total Energies Corbion Luminy® LX575 and LX175 as well as LX530. These resins have a melt flow rate of about 4.0 g/10 min. at 190° C./2.16 Kg test condition except that the melt flow of LX530 resin is about 9 to about 10 g/10 min., a crystallization temperature of about 145 to about 170° C., a glass transition temperature of about 55-62° C., a density of about 1.25 g/cm³. PLA4032D, LX575 and LX530 has a melting point of about 163-173° C., which are more preferred crystalline PLA resins for thermal resistance application.

Ingeo™ PLA4043D and Luminy® LX175 has a melting point of about 145-152° C., lower Tm melting temperature of those PLA resins have the advantages of melting at lower extrusion temperatures as blended with biopolymers with poor thermal stability such as PHA resins. PLA resins with a Tm of about 150° C. melt earlier compared to PLA resins with a Tm of about 165° C. before PHA resin melts during extrusion, molten PLA resins can lubricate extrusion and facilitate PHA melting especially, as the PHA resins are PHB or PHBV resin having a Tm higher than 170° C. so that the extent of PHBV thermal degradation can be eliminated.

The crystallinity of commercial semi-crystalline PLA resins with a Tm in the range of about a145 to about 168° C. is in the range of about 35 wt % to about 45 wt % by controlling the ratio of L and D enantiomers that are used in polymerization.

Amorphous PLA resins include Nature Works Ingeo™ 4060D and TotalEnergies Corbion Luminy® LX975 and LX930. Those resins have a melt flow rate of about 4 to 6 g/10 min. at 190° C./2.16 Kg test condition except that the melt flow of LX930 resin is about 9 to 10 g/10 min., a glass transition temperature of Tg about 52-60° C. (softening temperature), heat seal initiation temperature of about 93° C., a density of about 1.24 g/cm³. Molecular weight Mw is about 180,000 g/mole. As it has been well known that there are no melting temperatures for amorphous PLA resins. As amorphous PLA resins are heated to their glass transition temperature Tg around about 56° C., the PLA chains can flow, and form entanglements, which create seals (solidifying) as the PLA chains are cooled to the temperatures lower than Tg about 56° C.

PLA copolymers include but not limited to lactide-rich copolymers such as poly(lactide-co-glycolide) (PLA-co-GA), poly(lactide-co-hydroxyalkanoate) (PLA-co-HA), poly(lactide-co-3hydroxypropionate) (PLA-co-3HP), and poly(lactide-co-ε-caprolactone) (PLA-co-ε-CL) copolymers, those PLA copolymers are home compostable as the molar fraction of comonomers reach a threshold for example 20 mole %. The comonomers such as glycolide, 3hydroxypropionate, and ε-caprolactone copolymerized with L and D enantiomers so that comonomers can be inserted into PLA backbone to improve the flexibility and compostability of PLA copolymer resins. The PLA copolymers can be either semi-crystalline or amorphous, depending on the ratio of the D, L enantiomers as well as non-lactide monomers.

In an embodiment, PLA copolymers can be random or block copolymers of poly(lactide-co-glycolide) (PLA-co-GA), poly(lactide-co-hydroxyalkanoate) (PLA-co-HA), poly(lactide-co-3hydroxypropionate) (PLA-co-3HP), and poly(lactide-co-ε-caprolactone) (PLA-co-ε-CL) copolymers. Random PLA copolymers with GA, CL and HA comonomers have improved biodegradability and home compostability according to the chemical structure since the homopolymer of GA, HA and CL are home compostable. Preferably, the molar fraction (y) of comonomers in the PLA backbone structure in the range 5 to 20 mole %. Structures of random PLA copolymers with home compostability are:

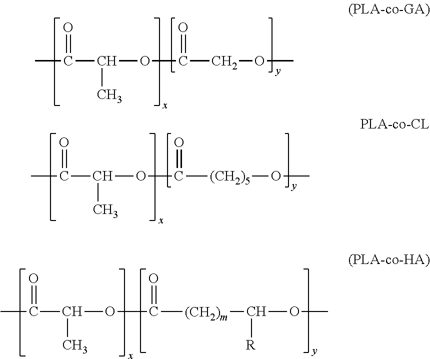

Wherein the number m in PLA-co-HA structure can be equal to 1, 2 or 3.

Polyhydroxyalkanoates (PHA) resin has a copolymer structure of poly((3HB)ₙ-co-(mHZ)₍₁₋ₙ₎), where H=hydroxy; B=butylene; m is the position number of hydroxy group on the carbon chain of alkanoic acid (m=3 or 4 or 5); Z is the alkanoate in the copolymer (Z=Butylene (B), Valerate (V), Hexanoate (Hx), Octanoate (O), and Decanoate (D) or mixtures thereof); n is the mole ratio of 3HB and (1-n) is the mole ratio of mHZ in the copolymer structure. Both the mole ratio (3HB/mHZ) and the structure of mHZ dominate the basic properties of PHA resins, especially, the crystallinity and melting temperature of the PHA resins. As n=1, the PHA resin is a PHB homopolymer. PHB homopolymer has a Tg of about 9° C. and a melting temperature of about 175 to about 178° C. It is a very rigid biopolymer due to its high crystallinity. PHA resins have a Tg in the range of −44° C. ≤Tg≤9° C. and a Tm of in the range of about 120 to 178° C. (Appl. Sci. 2017, 7, 242, herein reference is listed for convenience). Amorphous PHA resins comprise a high mole ratio of mHZ monomer so that the PHA copolymers has a Tg less than ≤−10° C., they are very rubbery biopolymers. Common engineering PHA biopolymers include PHB, P3HB-co-4HB, PHBV, PHB-co-3HHx, PHB-co-4HHx, PHB-co-3HO, and PHB-co-3HD.

An example of PHBV resins include TianAn Enmat™ Y1000P, poly(3-hydroxybutyrate-co-3-hydroxyvalerate) (PHB-co-3HV or PHBV). An amount of from about 0.5 to 1 mol % 3hydroxyvaleric acid comonomer (3HV) produced form petroleum-based chemicals as a precursor was added into feedstock in fermentation process to synthesize the copolyester of PHBV. The short side chain (ethyl group CH₂CH₃) of 3HV can incorporate into PHB crystals, leading to a high melting point of about 175° C. and a high crystallinity (78%) according to the data obtained from the analysis of differential scanning calorimetry (DSC) experiment. PHBV has a glass transition temperature of about 2° C. and a melt flow index 8 to 15 g/10 min., and a density of 1.25 g/cm³. Y1000P is a very rigid biopolymer due to its high crystallinity. A reversed extrusion temperature profile is preferably needed for extruding the PHBV resin for the sake of preventing from significant thermal degradation, preferably, an amount of low Tm flexible biopolymers, amorphous biopolymers, and plasticizers or mixture thereof could be blended into the PHBV resin in the core layer in extrusion to facilitate PHBV melting and eliminate its thermo-mechanically induced degradation.

Examples of PHB-co-3HHx with a comonomer of propyl side chain include Bluepha™ BP330-05 and BP35005, which have a glass temperature of −3 to 6° C. and a melting temperature of about 125 to about 152° C., and a melt flow rate of about 2 to about 5 g//10 min tested under conditions of about 165° C. and about 2.16 Kg.

Low Tg flexible home compostable biopolymers include polybutylene succinate-co-adipate (PBSA) resins and polycaprolactone (PCL) resins.

One suitable example of PBSA resins could be PTT MCC BioPBS™ FD92PM, which has a glass transition temperature (Tg)−47° C. and a melting temperature (Tm) 87° C., and a melt flow index 4 grams/10 min. at 190° C./2.16 Kg standard condition. Suitable examples also include BioPBS™ FX85AC resins which has high melt flow index at about 15 g/10 min. and are TUV-certified for home compostable application.

One suitable example of PCL resins could be Ingevity CAPA®6500D, CAPA®6800D and CAPARFB100, which have a glass transition temperature (Tg) about −60° C. and a melting temperature (Tm) about 58° C. and melt flow index of about 30 g/10 min. and 4.1 g/10 min. and 2 g/10 min., respectively, under 190° C./2.16 Kg test condition. Those biodegradable polymers are certified for both industrial composting and home composting by TUV Austria Group.

Poly(butylene adipate-co-butylene-terephthalate) (PBAT) resin is also a low Tg flexible biopolymer. One example of PBAT resins is BASF ecoflex® C1200, which has a density of about 1.25 g/cm³, a glass transition temperature of about −30° C. However, The PBAT melts between about 50° C. and about 150° C. with a flat peak at about 120° C. and has a very low crystallinity of only around 15%. a Vicat softness of about 91° C., it is a very rubbery and soft biopolymer. Ecoflex® C1200 can provide good effects on modulus reduction and sound dampening. Unfortunately, PBAT is not certified for home compostable application.

Multi-functional epoxidized or grafted maleic anhydride groups can chemically react with the chain end groups (—COOH) of polyesters. Suitable examples of multi-functional reactive polymeric resins with the functional groups include amorphous maleic anhydride modified SEBS Kraton™ FG 1924 polymer and Dow Biomax® SG 120 resin.

Kraton™ FG 1924 polymer is an amorphous elastomer having a glass transition temperature of about −90° C. for its polybutadiene blocks and a Tg of about 100° C. for its polystyrene blocks, the weight percentage of polystyrene blocks is only about 17 wt %. Therefore, FG 1924 is a very rubbery material with excellent flexibility for modification at a low loading amount.

Biomax™ SG 120 is a type of epoxidized ethylene-acrylate copolymers or terpolymers (non-biodegradable polyolefin elastomers) with contemplated structures of ethylene-n-butyl acrylate-glycidyl methacrylate, ethylene-methyl acrylate-glycidyl methacrylate, ethylene-glycidyl methacrylate, or blends thereof. This additive has a density of about 0.94 g/cm³, a melt flow rate of about 12 g/10 min. at about 190° C./2.16 kg test condition, a melting point of about 72° C., and a glass transition temperature of about −55° C.

Spherical antiblocks are necessary for film making. The spherical antiblocks includes crosslinked silicone polymer such as Tospearl® grades of polymethlysilsesquioxane of nominal about 2.0 and about 3.0 μm sizes and sodium aluminum calcium silicates of nominal 3 μm or 5 μm in diameter (such as Mistui Silton® JC-30 and JC-50).

PLA10A is an antiblock masterbatch comprising about 5 wt % Silton® JC-30 particles and about 95 wt % amorphous PLA carrier resin Luminy®LX975, it was made through toll compounding.

PLA03-3 is a pre-compounded PLA-rich alloy composition with about 20 wt % polycaprolactone CAPA®6500D, 38.9 wt % LX575, 38.9 wt % LX575, 2 wt % sebacic acid, 1.2 wt % Joncryl ADR 4468 and 0.2 wt % Zn St. the composition has improved flexibility and home compostability. It was made through toll-compounding.

The primer compositions in the present invention include aqueous polyethyleneimine dispersion and polyester dispersions.

Linear PEI, —(CH₂CH₂NH)ₙ—, is the nitrogen analog of PEO, has a glass transition of −29.5° C. (reference: Pharmaceutics 2022, 14, 2671). The linear PEI is a semi-crystalline solid at room temperature having a melting temperature of 67° C. While branched PEI is a fully amorphous polymer existing as a liquid at all molecular weights. Both linear and branched polyethyleneimine is soluble in hot water and can be stored at room temperature. On organic supports, PEI can usually react with surface anchor groups of films and covalently bound onto the surface. PEI has been used for the modifications of adhesion on polymeric substrates such as PET film or fibers. Crosslinkers such as 1,4-Butanediol diglycidyl ether (BUDGE) can be used to cross-link the PEI entities, creating better-ordered and greater density phases together with hydrogen bonds between abundant amine groups, forming moisture-resistant anchoring structure on the substrates, either or both of which are smooth and relatively inert chemically. The mobility of polymer chains plays a key role in structural bonding interactions because reversible interactions can cause structure instability at molecular level which form damaged areas in the process of reorganization due to the mobility of molecular fragment structure. Cross-linking and anchoring suppress the mobility of polymer segments or chains thereby elimination bonding reversibility, resulting in mechanical robustness of polymeric substrate.

Examples of polyethyleneimine include MICA A-131.X and Mica H-760-A aqueous dispersions. MICA A-131-X is a water-based polyethyleneimine primer containing 5 wt % solids. Mica-H760-A is a single component, concentrated aqueous polyethyleneimine dispersion supplied by Mica Corporation to promote the adhesion of extruded sheet to various coatings and films. The aqueous dispersion has a solid content of about 12 wt % and the solid showed a glass transition temperature of about 84° C. based the DSC data of solvent cast dried Mica-H760-A sample.

The composition of aqueous polyester dispersion comprises a water dispersible copolyester, suitable surfactants as well as crosslinkers, which is uniformly mixed to produce a primer coating for polymeric films to improve the adhesion between substrate and barrier coating or inks.

Examples of suitable polyester dispersion include Eastman Eastek™ 1100 and Eastek 1200. Eastek 1100 is an aqueous dispersion of AQ™ 55S water-dispersible sulfopolyester resin supplied by Eastman. It is an aqueous sulfopolyester resin dispersion containing 30% solid with a glass transition temperature of 55° C. Eastek™ 1200 is an aqueous sulfopolyester dispersion of AQ™ 65S water-dispersible sulfopolyester resin, containing 30% solid with a glass transition temperature of 65° C.

Adhesion promoter could be optionally added into a waterborne dispersion to improve the adhesion between primer and a polymeric substate. Suitable examples of adhesion promoters include Eastman Advantis™ 510W, which is a waterborne, chlorine-free and APEO free adhesion promoter.

It is well known that cross-linkable EVOH/PVOH barrier layer can be metallized to greatly improve oxygen barrier properties, since these polar polymers are well-known for their oxygen-barrier properties rather than moisture barrier. To develop an aqueous coating solution, water-soluble EVOH grades (ethylene content <10 mole %) should be selected for the sake of preparing waterborne coating solution. Suitable EVOH resins with low ethylene content might have a Tg in excess of 60° C. and relatively low molecular weight of 80,000-130,000 g/mol. PVOH is water soluble and easy to form aqueous coating grades and forming film. Suitable PVOH resins might have a Tg of 75-85° C. and a molecular weight of from 85,000-124,000 g/mol. Although PVOH can give good oxygen gas barrier properties, it is prone to loss barrier properties under humid conditions wherein the water molecules can cause swelling and plasticization of the barrier coating layer. EVOH with ethylene content has slightly better moisture resistance due to its inherent ethylene chain segment compared to PVOH. By blending EVOH and PVOH to form a coating composition, one can improve the moisture resistance of the barrier coating layer; by crosslinking the barrier coating layer during the coating process, one can further improve the moisture resistance. By doing this, swelling and plasticization can be restricted and eliminated so that the barrier properties of a film product can be maintained under humid conditions. Crosslinking effectively increases the “molecular weight” of the coating layer, making it a more durable and robust layer for improved cohesive strength which results in a stronger metal adhesion. Thus, it is desirable to crosslink both the EVOH and PVOH components of the coating on a primed bioplastic substrate.

Barrier coating TPB5K is an aqueous composition of EVOH and PVOH used for barrier improvement in the invention. TPB5K is proprietary barrier coating of Toray Plastics (America), Inc.

### Film Structure

In an embodiment, the multilayer film is a three-layer film comprising a polymeric core layer sandwiched by two outer skin layers, the core layer is considered as the base layer to provide the bulk strength and mechanical properties of the composite film.

In an embodiment, the core layer (B) comprises PLA resin, PHA resin and modifiers at an amount described previously in this document.

In an embodiment, the modifier in the core layer comprises biopolymers including PBS, PBSA, PBAT, PCL, and random PLA copolymers such as PLA-co-3HP, PLA-co-ε-CL and PLA-co-GA resins having a glass transition temperature of Tg≤60° C.

In an embodiment, the core layer optionally further comprises petroleum-based flexible polymers as modifier with a Tg≤0° C. at an amount of less than about 5 wt % of the total weight of the core layer.

In an embodiment, the film comprises two outer layers comprising bioplastics certified for industrial composting or home composting application.

In an embodiment, the second outer layer has a composition the same as the first outer layer.

In an embodiment, the second outer layer has a composition different from the first outer layer.

In an embodiment, the second outer layer is a heat sealant layer.

In an embodiment, the film comprises a core layer, a non-heat sealable layer and a heat sealable layer.

In an embodiment, the aqueous primer (polyethyleneimine or polyester) dispersion is coated on the top surface of the first outer layer (non-sealable layer) by either inline or offline processes.

In an embodiment, the EVOH/PVOH barrier coating solution is then coated on the top surface of primer layer of the primed film in an offline process.

In an embodiment, the barrier-coating-coated film above is then offline metallized by a process of physical vapor deposition of aluminum.

In an embodiment, the barrier-coating-coated film above could also be offline coated with a metal oxide layer comprising aluminum oxide, titanium oxide and aluminum-titanium oxide using the method of atomic layer deposition.

In an embodiment, the film is either non-oriented, or oriented in machine direction (MD), or oriented in both machine direction (MD) and transverse direction (TD).

In an embodiment, this invention provides a method of improving the moisture barrier properties of compostable composite film through processes of priming, barrier coating and metallization as well as formulations of primers, barrier coatings and bioplastic film that is biodegradable.

Film Preparation, Priming, Solution barrier-coating, and Metallization

Base film preparation: in an embodiment in the current invention, examples were practiced on a film making line armed with a three-layer 12-inch-wide flat die for molding, two chill rolls for cooling the hot polymer melt curtain, multiple heated and sped rollers for MD orientation and a tenter frame oven for TD orientation, and in-line discharge treatment and a film winding system. The main polymeric composition either in the core layer or in the outer layers is either industrial compostable or home compostable polymeric composite described earlier. The multi-layer laminate sheet was coextruded at extrusion temperatures designed for each layer, and the cast and pinned—using electrostatic pinning—onto a cooling drum wherein the surface temperature was controlled between about 15° C. and about 35° C. to solidify the non-oriented laminate sheet at a casting speed of about 7 to about 11 about mpm (meter per minute). The non-oriented laminate sheet was stretched first in the machine direction at about 40° C. to about 65° C. at a stretching ratio of about 2 to about 3.5 times the original length, using differentially heated and sped rollers and the resulting stretched sheet is heat-set at about 40-50° C. on annealing rollers and cooled at about 30-40° C. on cooling rollers to obtain a uniaxially oriented laminate sheet. The uniaxially oriented laminate sheet is then introduced into a tenter oven at a line speed of about 25 to about 38 mpm and preliminarily heated between about 60° C. and about 75° C., and stretched in the transverse direction at a temperature of about 75 to about 95° C. at a stretching ratio of about 3 to 5 times the original width and then heat-set or annealed at about 90 to about 140° C., preferably about 110 to about 140° C., and more preferably about 120 to about 140° C. for making a film with low heat shrinkage to reduce internal stresses due to the orientation and minimize shrinkage and give a relatively thermally stable biaxially oriented sheet. TD orientation rates were adjusted by moving the transverse direction rails in or out per specified increments based on the TD infeed rail width settings and width of the incoming machine-direction oriented film. The film is relaxed by about 5 to about 15% in TD and then optionally be passed through an in-line corona discharge-treatment system in a controlled atmosphere as described previously to whatever desired surface energy. Typically, useful surface energy can be about 36 to about 50 dyne/cm. The film is then wound into a roll form through film winding equipment. The biaxially oriented film has a total thickness between about 10 and about 100 μm, preferably between about 15 and about 30 μm, and most preferably between about 17.5 and about 25 μm.

In-line priming: the uniaxially oriented laminate sheet after MD orientation was corona-discharge treated on the first outer layer, then aqueous dispersion of primer coating was coated on the treated surface (the surface of coating receiving layer) by a gravure coater, and then the coated film was introduced into a tenter oven at a line speed of about 25 to about 38 mpm to stretch in traverse direction under the same conditions as that for non-coated film described above. The stretched film was annealed at about 90 to about 140° C. and then relaxed at about 5% to about 15% in TD. The heat in the preheat ovens of the tenter effectively acts as a drier to remove the solvent (water), leaving the dried polymeric coating adhered to the substrate. The coat weight of dried polymeric coating was in the range of from about 0.01 to about 0.1 gsm. The oven temperatures in the tenter ovens could help promote the crosslinking of the dried polymeric coating and enhance the reaction of primer anchoring structure on substrate. The coated primer is stretched together with the film in the transverse direction, thus stretchability is required for the polymeric primer. In the case of a simultaneous biaxial orientation process, the in-line coating station can be placed between the casting section and the orientation oven. The coated primer will be stretched together with the film in both machine direction and transverse direction. Multiple rolls of in-line primed biaxially oriented plastic films were formed into a composite roll for solution barrier coating. A lead film (either BOPET, or BOPP, or BOPLA) with a footage of about 1200 m could be incorporated into the start and end session of the composite roll.

Off-line priming: a composite roll of the biaxially oriented bioplastic films prepared by using the methods described previously was mounted on the unwind stand of an off-line solution coater. The composite roll had a width of about 24 inches (about 61 mm) with a lead film incorporated into the start and end of the composite roll. The treated side of the film was corona-discharge treated in-line and then the treated surface was coated with an aqueous primer dispersion of the respective examples using a reverse-gravure coater. Coating speed was about 120 to about 180 mpm (meter per minute). The primed film was dried in an 3-zone air flotation oven at about 38 to about 70° C., such that any thermal shrinkage of the bioplastic film was kept to a minimum. After drying, the primed bioplastic film was wound into roll form for barrier coating. The dried coat weight of the polymeric primer was about 0.01 to about 0.1 gsm.

Solution barrier coating: a roll of the primed bioplastic film after aged for about 24 hrs was mounted on the unwind stand of an off-line solution coater, about 24 inches (ca. 61 mm) width. The primed side of the bioplastic composite film was coated with an aqueous EVOH/PVOPH coating formulation using a reverse-gravure coater. Coating speed was about 120 to about180 mpm. The coated film was dried in a 3-zone air flotation oven at about 38 to about 70° C. After drying, the coated bioplastic film was wound into roll form for metallizing. The dried coat weight of the barrier coating was about 0.15 to about 0.35 gsm.

Metallization: the coated film roll (24-inch wide roll, made through processes of priming and solution barrier coating) was then placed in a vacuum metallizer for physical vapor deposition of aluminum upon the coated surface. The coated surface of the film was discharge treated prior to aluminum vapor deposition within the metallizing vacuum chamber. The line speed of metallizing was about 160 mpm. The optical density of metal layer was about 2.4. The metallized film samples were collected from the metallized rolls and tested for properties.

This invention will be better understood with reference to the following examples, which are intended to illustrate specific embodiments within the overall scope of the invention.

### EXAMPLES

The compositions of each layer of the coextruded composite films made in Examples are shown in Table 1, 2 and 3.

### Examples 1 to 3

Three-layer coextruded biaxially oriented composite films were made using processes of coextrusion (three extruders), casting and sequential orientation on a 12-inch-wide flat die line as described previously, including first outer layer (A), a core layer (B), and second outer layer (heat sealable) (C). The core layer of the composite film was modified with 4 wt % flexible polymer BIOMAX SG 120 resin (shown in Table 1). The core layer was sandwiched between two outer layers. JC-30 antiblock particles were added into two outer layers through pre-compounded PLA10A masterbatch for the purpose of COF control.

The dry blended resins of each layer were melt coextruded individually in extruder A (first outer layer, cast side or drum side), B (core layer) and C (second outer layer, air side) at temperatures of about 204° C. The molten resins flowed through a set of screen packs and individual melt pipes set at temperature of 204° C. and then met inside the die body of a twelve-inch flat die set at temperature of 204° C., resulting in a curtain of molten resin. The resin curtain was then cast on a first chilled drum (CD1, chilled-roll 1, set at temperature about 30° C.) using an electrostatic pinner and annealed on a second chilled drum (CD2, or chilled-roll 2, set at temperature about 20° C.). The formed cast sheet was stretched in machine direction (MD) through rolls set at temperatures between 40° C. to 65° C. and then stretched in transverse direction (TD) in a tenter oven set temperatures 65-82° C. The resultant biaxially oriented film was subsequently annealed and then relaxed, followed by discharge-treated on the surface of the first outer layer (A) opposite the second outer layer (C) via corona treatment. Conditions of film making were shown in Table 4.

The total thickness of this film substrate after biaxial orientation was attempted to be about 20 μm. After biaxial orientation, the thickness of the core layer (B), the first outer layer (A), and the send outer layer (C) was about 17.0 μm, 1.0 μm, and 2.0 μm, respectively.

### Example 4 to 5

Example 3 were repeated while conditions and formulations were changed. The core layer of Examples 4 and 5 comprises a composition of Y1000P, PLA4043D and BIOMAX SG 120. The temperatures of the extruder (and its pipe) of the core layer were reduced to a range of between 160 to 180° C. for eliminating the thermal degradation of Y1000P resin.

### Example 6

Example 3 were repeated while the conditions and formulations were changed. The formulation of the core layer and the first outer layer was changed to PLA03-3, which is PLA nano-alloy compound with improved biodegradability. The formulation of the second outer layer was changed to a mixture of heat sealable resins with improved sealability.

### Off-Line Priming

The biaxially oriented composite films of Ex. 1 to 3 were formed into a composite roll and then off-line coated with Mica-H-760-A using the process and conditions described previously. The coat weight was controlled (by dilution to control solid weight in dispersion) at about 0.01 g/m².

The biaxially oriented composite films of Ex. 4 to 6 were formed into a composite roll and then off-line coated with Mica-H-760-A using the process and conditions described previously. The coat weight was controlled at about 0.025 g/m².

The primer, coat weight and off-line priming conditions were shown in Table 5.

### In-Line Priming

The primed composite film made by in-line priming process has an oriented primer layer which experienced much higher oven temperature compared to that of the off-line primed composite film. The coat weight was adjusted by coater roll BCM, solid weight in solution and light speed. The primer, coat weight and in-line priming conditions were showed in Table 5.

### Example 7

Example 2 was repeated, a coating station was set up between the MD orientation and TD orientation. Mica-H-760-A was coated on the corona-treated first outer layer of the MDO film using a 11BCM gravure roll coater and methods and conditions described previously, and the film with aqueous dispersion on it was dried and then oriented in transverse direction. The coat weight was controlled to be about 0.05 g/m².

### Example 8

Example 7 was repeated. Mica-H-760-A was modified using adhesion promoter Advants™ 510W at a ratio of about 3.6:1. Modified Mica-H-760-A dispersion was coated on the corona-treated first outer layer of the MDO film using the methods and conditions described previously, and the film aqueous dispersion on it was dried and then oriented in transverse direction. The coat weight was controlled to be about 0.05 g/m².

### Example 9

Example 7 was repeated. Eastek™ 1100 was coated on the corona-treated first outer layer of the MDO film using a 11BCM gravure roll coater and methods and conditions described previously, and the film aqueous dispersion on it was dried and then oriented in transverse direction. The coat weight was controlled to be about 0.05 g/m².

### Example 10

Example 9 was repeated. Eastek™ 1200 was coated on the corona-treated first outer layer of the MDO film using a 11BCM gravure roll coater and methods and conditions described in detail previously, and the film with aqueous dispersion on it was dried and then oriented in transverse direction. The coat weight was controlled to be about 0.05 g/m².

The in-line primed composite films in Examples 7 to 10 were formed into a composite roll for solution-barrier coating.

### Off-Line Barrier Coating

The primed surface of the composite films in Examples (in three different composite rolls) was off-line coated with cross-linkable EVOH/PVOH barrier coating solution (TPB5K barrier coating, proprietary technology of Toray Plastics (America), Inc.) using the conditions described previously. The dried coat weight of EVOH/PVOH was controlled at about 0.23 g/m².

### Metallization

After the composite films were coated with EVOH/PVOH barrier coating, then the coated surface of the composite films in the Examples were metallized in a metallizing chamber by physical vapor deposition of aluminum metal wires using the conditions described previously. The optical density (OD) of the metallized composite films was controlled to a level of about 2.4.

### Surface Roughness

The first outer layer of the biaxially oriented composite films, including not inline primed base films and in-line primed composite films made in pilot film line (12-inch-wide flat die line), was bell-jar metallized using a lab scale vapor deposition chamber armed with vacuum capability and aluminum metal wire. The surface roughness Ra of the composite films was measured using Keyence digital microscope and showed in Table 6. Surface roughness Ra is calculated as the Roughness Average of a surface measured microscopic peaks and valleys.

The first outer layer of Ex. 1 to 3 was changed to have different formulations while the examples were made with the same formulation in the core layer and the second outer layer using the same stretching ratio and heat set temperature. The surface roughness Ra of the composite films in Examples varied greatly in the range of 34 to 171 nm with changing outer skin recipes. The outer skin layer of Ex.2 showed the lowest surface roughness (Ra=34 nm), which is much smoother than other composite films. Ex. 3 with a Ra of 171 nm showed the highest surface roughness among the examples in the invention.

The core formulations of Ex. 4 to 6 were changed to comprising home compostable PHA (Y1000P) and nano-alloy PLA03-3 resins, and the outer layers were changed to different formulations. The first outer layer of Ex. 4 with a Ra of 36 nm showed the lowest surface roughness among the three composite film. Amorphous LX975 in the first outer layer of Ex. 4 improved the smoothness of the outer surface, compared to that of Ex. 5 with only semi-crystalline PLA resin. The first outer layer of the composite film in Ex. 6 with a Ra of 86 nm has the same materials as that in the core layer except for the JC particles in the outer layer for COF control.

The first outer layer of the composite films in Ex. 7 to 10 with a Ra in the range of 27 to 31 nm was in-line primed using different waterborne dispersions. Surface roughness Ra did not vary greatly with changed primers. The surface roughness Ra of the in-line primed composite films made with the same formulations and conditions is slightly lower, compared to that of the not primed composite film made in Ex. 2 (with a Ra of 34 nm).

### Barrier Properties

According to the disclosure of U.S. Pat. No. 8,734,933, a typical MVTR value of metallized BOPLA film is at about 4.5 g/m²/day and a typical MVTR value of metallized EVOH/PVOH coated BOPLA film is in the range 0.76 to 0.90 g/m²/day. Table 5 showed that the barrier properties of the metallized composite films in Examples were improved significantly, in particular, compared to the MVTR of typical metallized EVOH/PVOH-coated BOPLA film. The moisture barrier of the metallized composite film meets the MVTR target less than 0.5 g/m²/day required for snack food packaging. All metallized film samples also showed good metal appearance, no issue such as yellowish color was observed.

The composite film samples with different base film substate made through off-line priming process showed good O2TR in the range of about 2 to 4.5 cc/m²/day which meets the O2TR target less than 10 cc/m²/day required for snack food packaging.

Furthermore, the metallized composite films in Ex. 7 to 10 made with in-line priming process showed significant improvement in both oxygen and moisture barrier properties. The improved O2TR is in the range of 0.63 to 1.05 cc/m²/day, the improved MVTR is in the range of 0.027 to 0.075, which on average is about one order lower than the O2TR and MVTR required for snack food packaging. Orientation and higher oven temperature of in-line priming process enhanced the moisture-resistant anchoring function on the barrier coating and greatly improve the barrier properties of metallized barrier composite films.

Overall, surface roughness does have influence on barrier properties in case of significant variations, the barrier properties of the metallized composite films in Examples would not change significantly if variation in surface roughness is not high.

TABLE 1
Formulations of the core layer (B) of the coextruded composite films in Examples

| | Formulation of core layer (B)-wt % | | | | | |
|---|---|---|---|---|---|---|
| Examples | LX575 | BIOMAX120 | LX975 | Y1000P | PLA4043D | PLA03-3 |
| Ex. 1 | 81 | 4 | 15 | | | |
| Ex. 2 | 81 | 4 | 15 | | | |
| Ex. 3 | 81 | 4 | 15 | | | |
| Ex. 4 | | 4 | | 70 | 26 | |
| Ex. 5 | | 4 | | 60 | 36 | |
| Ex. 6 | | | | | | 100 |
| Ex. 7 | 81 | 4 | 15 | | | |
| Ex. 8 | 81 | 4 | 15 | | | |
| Ex. 9 | 81 | 4 | 15 | | | |
| Ex. 10 | 81 | 4 | 15 | | | |

TABLE 2
Formulations of the 1st outer layer of the coextruded composite films in Examples

| | Formulation of 1^{st} outer layer (A)-wt % | | | | | |
|---|---|---|---|---|---|---|
| Examples | LX975 | PLA10A | LX175 | FD92PM | PLA4043D | PLA03-3 |
| Ex. 1 | 94 | 6 | | | | |
| Ex. 2 | 15 | 1 | 84 | | | |
| Ex. 3 | | 1 | 29 | 70 | | |
| Ex. 4 | 49.4 | 0.6 | | | 50 | |
| Ex. 5 | | 0.6 | | | 99.4 | |
| Ex. 6 | | 0.6 | | | | 99.4 |
| Ex. 7 | 15 | 1 | 81 | | | |
| Ex. 8 | 15 | 1 | 84 | | | |
| Ex. 9 | 15 | 1 | 84 | | | |
| Ex. 10 | 15 | 1 | 84 | | | |

TABLE 3
Formulations of the 2nd outer layer of the
coextruded composite films in Examples

| | Formulation of 2^{nd} outer layer (C)- wt % | | | | |
|---|---|---|---|---|---|
| Examples | LX975 | PLA10A | PLA4043D | FD92PM | CAPA6500D |
| Ex. 1 | 94 | 6 | | | |
| Ex. 2 | 94 | 6 | | | |
| Ex. 3 | 94 | 6 | | | |
| Ex. 4 | 94 | 6 | | | |
| Ex. 5 | | 0.6 | 99.4 | | |
| Ex. 6 | 64 | 6 | | 20 | 10 |
| Ex. 7 | 94 | 6 | | | |
| Ex. 8 | 94 | 6 | | | |
| Ex. 9 | 94 | 6 | | | |
| Ex. 10 | 94 | 6 | | | |

TABLE 4
Orientation ratio, heat set temperature,
and TD relaxation used in Examples

Conditions of orientation

| | | | Anneal. | TD |
|---|---|---|---|---|
| Examples | MDX | TDX | Temp (° C.) | relax. (%) |
| Ex. 1 | 2.8 | 4.75 | 138 | 10 |
| Ex. 2 | 2.8 | 4.75 | 138 | 10 |
| Ex. 3 | 2.8 | 4.75 | 138 | 10 |
| Ex. 4 | 2.8 | 4.5 | 105 | 10 |
| Ex. 5 | 2.3 | 4.75 | 116 | 10 |
| Ex. 6 | 3.3 | 4.75 | 138 | 10 |
| Ex. 7 | 2.8 | 4.5 | 138 | 10 |
| Ex. 8 | 2.8 | 4.5 | 138 | 10 |
| Ex. 9 | 2.8 | 4.5 | 138 | 10 |
| Ex. 10 | 2.8 | 4.5 | 138 | 10 |

TABLE 5
Primer, coat weight, and oven temperatures used in Examples

primer, coat weight, and oven temperature

| | | Coat | |
|---|---|---|---|
| | | weight | |
| Examples | Primer | (gsm) | Oven temp (° C.) |
| Ex. 1 | H-760-A | 0.01 | 38/55/60 |
| Ex. 2 | H-760-A | 0.01 | 38/55/60 |
| Ex. 3 | H-760-A | 0.01 | 38/55/60 |
| Ex. 4 | H-760-A | 0.025 | 38/55/60 |
| Ex. 5 | H-760-A | 0.025 | 38/55/60 |
| Ex. 6 | H-760-A | 0.025 | 66/66/66 |
| Ex. 7 | H-760-A | 0.05 | 68/79/138 |
| Ex. 8 | Modified H-760-A | 0.05 | 68/79/138 |
| Ex. 9 | Eastek 1100 | 0.05 | 68/79/138 |
| Ex. 10 | Eastek 1200 | 0.05 | 68/79/138 |

TABLE 6
Surface roughness and barrier properties

| | Ra | O2TR | MVTR |
|---|---|---|---|
| Examples | (nm) | (cc/m²/day) | (g/m²/day) |
| Ex. 1 | 82 | 4.47 | 0.127 |
| Ex. 2 | 34 | 2.45 | 0.099 |
| Ex. 3 | 171 | 3.62 | 0.218 |
| Ex. 4 | 36 | 2.32 | 0.367 |
| Ex. 5 | 131 | 1.92 | 0.181 |
| Ex. 6 | 86 | 2.15 | 0.263 |
| Ex. 7 | 30 | 0.63 | 0.039 |
| Ex. 8 | 31 | 0.68 | 0.027 |
| Ex. 9 | 31 | 0.76 | 0.046 |
| Ex. 10 | 27 | 1.04 | 0.075 |

### Test Methods

The various properties in the above examples were measured by the following methods:

Coat weight was measured by the following gravimetric method. A coated substrate to be analyzed was dried and cut to a sample size of 4 inch by 4 inch (10 cm by 10 cm). The sample was weighed on an analytical balance with at least 2 decimal place accuracy. The coating was then removed by dissolving the coating composition in a solvent such as water or acetone. The sample was dried and weighed again. The difference between the coated and uncoated sample was reported as the dry coat weight in grams per square meter or “gsm”.

Surface roughness of the bell-jar metallized surface of the 1^{st} outer layer of the composite film was measured with a Keyence digital microscope. The first outer layer of the biaxially oriented composite film, including non-in-line primed base film and in-line primed base film, was bell-jar metallized using a lab scale vapor deposition chamber armed with vacuum capability and aluminum metal wire. In the measurements, roughness data of three samples were taken for each experiment. The mean value of these samples was calculated. Surface roughness Ra (nanometer) is calculated as the Roughness Average of a surface measured microscopic peaks and valleys. Surface roughness rms (nanometer) is calculated as the Root Mean Square of a surface measured microscopic peaks and valleys.

Moisture transmission rate of the metallized composite film was measured by using a Mocon Permatran 3/31 unit substantially in accordance with ASTM F1249 at the conditions of 38° C. and 90% relative humidity.

Oxygen transmission rate of the metallized composite film was measured by using a Mocon Oxtran 2/20 unit substantially in accordance with ASTM D3985 at the conditions of 23° C. and 0% relative humidity.

The above description is presented to enable a person skilled in the art to use the invention and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown in the description but is to be accorded the widest scope consistent with the principles and features disclosed herein.

### INCORPORATION BY REFERENCE

The entire disclosure of the patents and publications referred in this application are hereby incorporated herein by reference in their entirety.

1. A film comprising:
a core layer comprising a first biodegradable polymeric resin comprising a PLA resin or a PHA resin in an amount at least about 70 wt. % of total weight of the polymeric resins in the core layer,
one or more outer layer comprising a second biodegradable polymeric resin;
a barrier coating layer comprises EVOH or PVOH or a combination thereof, and a metal layer comprising a metal;
wherein the film is a biaxially oriented film; and
wherein the film has a moisture vapour transmission rate (MVTR) about 0.5 g/m²/day as measured according to ASTM F1249 and an oxygen transmission rate (O2TR) less than about 5 cc/m²/day as measured according to ASTM D3985.

2. The film of claim 1, wherein the film further comprises a primer layer between the one or more outer layer and the barrier coating layer.

3. The film of claim 2, wherein the primer layer comprising a coating comprising polyethyleneimine.

4. The film of claim 3, wherein the coating comprises a polyester.

5. The film of claim 1, wherein the film is industrial compostable according to ASTMD 6400 and/or ASTM D5388 (2021).

6. The film of claim 1, wherein the film is home compostable according to AS 5810-10 (2010).

7. The film of claim 2, wherein the film has an in-line coating of the primer layer.

8. The film of claim 2, wherein the film has an off-line coating of the primer layer.

9. The film of claim 7, wherein the film has the MVTR about 0.027 g/m²/day to about 0.075 g/m²/day as measured according to ASTM F1249 and the O2TR less than about 0.63 cc/m²/day to about 1.04 cc/m²/day as measured according to ASTM D3985.

10. The film of claim 8, wherein the film wherein has O2TR in a range of about 1.9 cc/m²/day to about 4.5 cc/m²/day and MVTR in the range of about 0.1 cc/m²/day to about 0.4 g/m²/day.

11. The film of claim 3, wherein the coating is water soluble dispersion.

12-16. (canceled)

17. The film of claim 1, wherein the barrier layer has a dried coat weight of EVOH or PVOH or a combination thereof in a range of about 0.15 gsm to about 0.5 gsm.

18. The film of claim 2, wherein the core layer, the one or more outer layer, the primer layer, the barrier and the metal layer are arranged in this order.

19-20. (canceled)

21. The film of claim 1, wherein the one or more outer layer has a surface roughness Ra in a range of 20 to 200 nm.

22. (canceled)

23. The film of claim 1, wherein the film has a thickness of about 10 μm to about 100 μm.

24-27. (canceled)

28. The film of claim 1, wherein the second biodegradable polymeric resin comprises PLA, PHA, PBS, PBSA, PCL, PBAT, a PGA copolymer, a PLA copolymer, a PHA copolymer, a chemically modified thermoplastic starches or combination thereof.

29. The film of claim 1, the core layer comprises an amount of less than about 5 wt % a petroleum-based polymeric modifier with a glass transition temperature of Tg≤10° C.

30-34. (canceled)

35. A film comprising a core layer having a first side and a second side, a first outer layer adjacent to the first side, an in-line primer coating layer adjacent to the first outer layer, a barrier coating layer adjacent to the in-line primer coating layer coating layer, and a metal layer adjacent to the barrier coating layer;
wherein:
the core layer comprises a biodegradable polymer comprising a PLA resin or a PHA resin in an amount at least about 90 wt. % of total weight of a polymeric resins in the core layer,
the in-line primer coating layer comprises a polyethyleneimine polymer or a polyester,
the barrier coating layer comprises EVOH or PVOH or combination thereof, and the metal layer comprises a metal;
wherein the core layer is substantially free of a fibre; and
wherein the film is a biaxially oriented film.

36-38. (canceled)

39. The film of claim 35, wherein the film has a moisture vapour transmission rate (MVTR) about 0.027 g/m²/day to about 0.075 g/m²/day as measured according to ASTM F1249 and an oxygen transmission rate (O2TR) less than about 0.63 cc/m²/day to about 1.04 cc/m²/day as measured according to ASTM D3985.

40. (canceled)

41. A film comprising a core layer having a first side and a second side, a first outer layer adjacent to the first side, a primer coating layer adjacent to the first outer layer, a barrier coating layer adjacent to the in-line primer coating layer coating layer, and a metal layer adjacent to the barrier coating layer;
wherein:
the core layer comprises a biodegradable polymer comprising a PLA resin or a PHA resin in an amount at least about 90 wt. % and less than about 5 wt % a petroleum-based polymeric modifier with a glass transition temperature of Tg≤10° C. of a total weight of a polymeric resin in the core layer,
the primer coating layer comprises a polyethyleneimine polymer or a polyester,
the barrier coating layer comprises EVOH or PVOH or combination thereof, and
the metal layer comprises a metal; wherein the core layer is substantially free of a fibre; and wherein the film is a biaxially oriented film.
